(19) United States
(12) Patent Application Publication
(10) Pub. No.: US 2022/0398884 A1
(43) Pub. Date: Dec. 15, 2022

(54) Retail Point of Sale Security System

(71) Applicant: Ashten Gilliard, Agency, MO (US)

(72) Inventor: Ashten Gilliard, Agency, MO (US)

(21) Appl. No.: 17/343,000

(22) Filed: Jun. 9, 2021

(51) Int. Cl. G07C 9/00; H04L 9/32

(52) U.S. Cl. CPC G07C 9/00658; H04L 9/3226

(57) ABSTRACT

The present disclosure is the only product of its kind that incorporates an advanced technology in keeper boxes to enhance protection protocols and sale security in retail locations. This disclosed product is uniquely designed with durable materials to ensure sustainability and a sound alarm to notify authorities and/or near by staff securities, if the device is being moved, tampered with or broken into, immediately. The disclosure includes an electronic security box made of a metal and comprising five contiguous sides and defining an open sixth side. The disclosure also includes a metal lid configured to fit the sixth side of the metal box and create an enclosure. The disclosure further includes a base configured to electronically interact with the metal lid and with the metal box via a proximity thereto.

### BACKGROUND

Retail companies lose large quantities of key merchandise because of errors, omissions, fraud, and theft. Lost inventory frustrates consumers, skews stocking processes, and reduces sales. Although some retailers use keeper boxes to store and protect precious items, modem designs can be easily hacked or broken into and therefore increases the probability of theft or robbery situations. There have been no products available as original equipment or as an aftermarket to address this problem.

A system or device to simplify the effort to keep key merchandise safe from theft, that aids in avoiding omissions, lost inventory, errors and fraud. There have been no products available as original equipment or as an aftermarket to address this problem either.

There exists a need for a device and a system for Retail Point of Sale Security, that is not being met by any known or disclosed device or system of present.

### SUMMARY OF THE INVENTION

The main purpose of the Retail Point of Sale Security System is to provide users with an anti-theft keeper box to ensure the product held therein is safe and incapable of being stolen.

The disclosure includes an electronic security box made of a metal and comprising five contiguous sides and defining an open sixth side. The disclosure also includes a metal lid configured to fit the sixth side of the metal box and create an enclosure. The disclosure further includes a base configured to electronically interact with the metal lid and with the metal box via a proximity thereto.

### BRIEF DESCRIPTION OF THE DRAWINGS

FIG. 1 is a top perspective view of the Retail Point of Sale Security System in accordance with an embodiment of the present disclosure.

FIG. 2 is a view of an open metal box with metal lid and a proximity base of the disclosed system in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

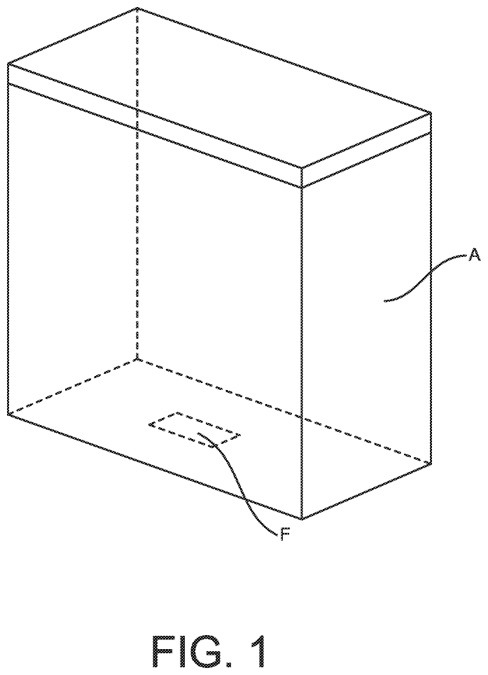

FIG. 1 is a top perspective view of the Retail Point of Sale Security System showing the metal box, also known as the Durable box electronically locked box referenced as A., and the switch F on a bottom of the metal box A. The box A forms an enclosure for retail point of sale items held therein to be retrieved by authorized agents or owners.

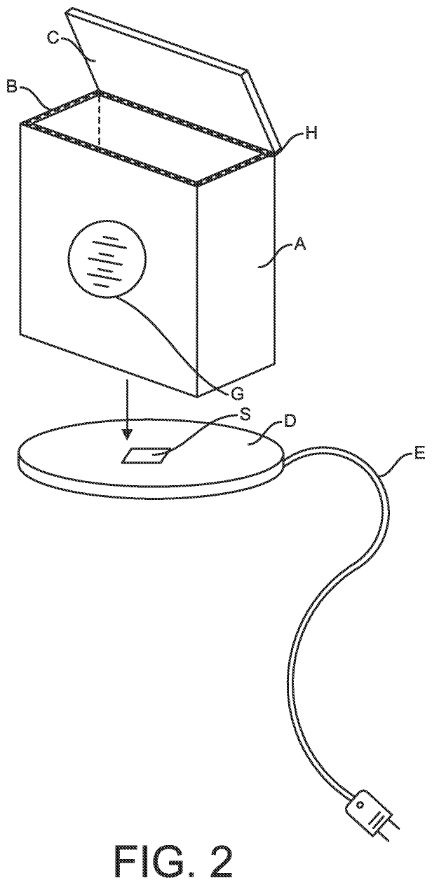

FIG. 2 is a view of an open metal box with metal lid and a proximity base of the disclosed system in accordance with an embodiment of the present disclosure. The view includes the metal box A, the sixth side opening B of the EAS system (will sound alarm when tampered with), the Lid (opens automatically when placed near pad) referenced as C., the base or Electronic pad (opens box when code identified) referenced as D., and the Power cord referenced as E., in accordance with an embodiment of the present disclosure. The view also includes the switch S which is complementary to the switch F in the bottom of the metal box A. The view additionally includes the hinge H joining the metal box A and the lid C. The view further includes the alarm G which is triggered by any form of tampering with the system including electronic, mechanical, hermetic and magnetic interferences.

The present disclosed Retail Point of Sale Security System ensures that items stored within the electronically locked box are safe at all times and unable to be tampered with. Expanding on the initial design of the average keeper box, the Retail Point of Sale Security System introduces a novel emergency alert system (EAS) that sounds an alarm when unusual activity is detected. With the help of an advanced point of sale (POS) technology, the system is capable of reading and randomly generating various access codes to guarantee hackers are unable to exploit and open the box. To operate the device, the user simply plugs the device into a power cord to activate the functions. When the user wants to open the box and retrieve the item held within, they simply place the Retail Point of Sale Security System near the electronic pad, which managed separately and by authorized users, which identifies the code and automatically opens the lid. The Retail Point of Sale Security System ensures a fully operational, secure, electronic storing compartment at all times and therefore significantly reduces the likelihood of internal theft occurrences.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An electronic security box comprising:
a metal box comprising five contiguous sides and defining an open sixth side;
a metal lid configured to fit the sixth side of the metal box and create an enclosure; and
a base configured to electronically interact with the metal lid and with the metal box via a proximity thereto.

2. The electronic security box of claim 1, further comprising a hinge on an adjacent side of the metal lid with the metal box.

3. The electronic security box of claim 1, further comprising an alarm triggered by an electronic tampering with the electronic security box.

4. The electronic security box of claim 1, further comprising an alarm triggered by a mechanical tampering with the electronic security box.

5. The electronic security box of claim 1, wherein the proximity of the base to the metal lid and the metal box includes a touching of all three components at a retail point of sale.

6. The electronic security box of claim 1, further comprising a mechanical code set in a switch in a bottom of the metal box complementary to a mechanical code in the base for an opening of the metal lid to occur.

7. The electronic security box of claim 1, further comprising a cryptographic code set in a switch in a bottom of the metal box complementary to a cryptographic code in the base for an opening of the metal lid to occur.

8. The electronic security box of claim 1, further comprising a lock connecting the metal lid with the metal box and open and set by a matching code in the base and in a bottom of the metal box.

9. The electronic security box of claim 1, further comprising a fail-safe lock of the metal lid to the metal box in a power failure event.

10. The electronic security box of claim 1, wherein the metal lid to metal box enclosure is waterproof.

11. The electronic security box of claim 1, wherein the metal lid to metal box enclosure is electromagnetic pulse proof.

12. The electronic security box of claim 1, wherein the metal lid to metal box enclosure forms a hermetic seal.

13. The electronic security box of claim 1, further comprising an alarm triggered by a tampering with the electronic security box via an audible vibration of a portion of the metal box.

14. The electronic security box of claim 1, further comprising an alarm triggered by a separation of the metal box from the base.

15. The electronic security box of claim 1, further comprising an alarm triggered by an unauthorized separation of the metal lid from the metal box.
